(19) United States
(12) Patent Application Publication
(10) Pub. No.: US 2012/0212428 A1
(43) Pub. Date: Aug. 23, 2012

(54) METHOD OF DESIGNATION OF DISPLAY PARTS

(76) Inventors: Vladimir Vitalievich Miroshnichenko, Ljubertsi (RU); Vitaly Evgenievich Pilkin, Moscow (RU)

(21) Appl. No.: 13/138,463

(22) PCT Filed: Nov. 15, 2010
(86) PCT No.: PCT/RU2010/000669

§ 371 Date: Aug. 22, 2011

(30) Foreign Application Priority Data
Nov. 16, 2009 (RU) 2009142181

(51) Int. Cl. G06F 3/041

(52) U.S. Cl. 345/173

(57) ABSTRACT

The invention relates to electronic devices and, in particular, to the method of designation and arrangement of a visual display in an electronic device and a device for the method realization. The first and the second embodiments of the invention are characterized in that at least one part of a visual display is designated differently from another part or parts of the visual display. The third, fourth, fifth, sixth, seventh and eighth embodiments of the invention are characterized in that a visual display is arranged on two, three, four and more than four sides of an electronic device body.

### CROSS-REFERENCE TO RELATED APPLICATIONS

This application is a U.S. national stage application of a PCT application PCT/RU2010/000669 filed on 15 Nov. 2010, whose disclosure is incorporated herein in its entirety by reference, which PCT application claims priority of a Russian Federation application RU2009142181 filed on 16 Nov. 2009. The PCT application PCT/RU2010/000669 also contains parts of disclosure absent in the application RU2009142181.

### FIELD OF THE INVENTION

The invention relates to electronic devices and, in particular, to the method of designation and arrangement of a visual display in an electronic device and a device for the method realization.

### BACKGROUND OF THE INVENTION

In general, a visual display is deemed any surface, displaying alphanumeric and/or graphic data, e.g., a computer monitor, a display board, a TV-screen, a mobile phone display screen and so on. Visual display may be touch screens display (display of a sensor type) and display of a non-sensor type. For more details see http://en.wikipedia.org/wiki/Electronic_visual_display. Touch screen display of an electronic device allows to control functions of an electronic device through a contact movement of a finger or a stylus on the surface of a touch screen display. For more details see http://en.wikipedia.org/wiki/Touchscreen. Display of a non-sensor type is representing a visual display where controlling an electronic device functions through a contact movement of a finger or a stylus on the said display surface is impossible. It is also known technology of manufacturing touch screen displays and visual displays of non-sensor type. This technology allows a part or parts of a visual display is/are functioning as a touch screen display and the rest part or parts of the same visual display is/are functioning as a visual display of non-sensor type. For more details see http://en.wikipedia.org/wiki/Touchscreen. There are also known electronic devices equipped with visual display, wherein device functions controlling is carried out through a visual display, but the said visual display is of a non-sensor type, e.g., Microsoft Surface. For more details see http://www.microsoft.com/surface/Pages/Product/WhatIs.aspx.

The mentioned technical solutions have the following disadvantages:
A user is not aware which part of the display is a touch screen display, and which part of the display is a display of a non-sensor type;
A user of a visual display of a non-sensor type is not aware, which part of the display is available for touch manipulations;
Above mentioned visual displays (regardless of the visual display type) cannot be arranged on several sides of an electronic device body at once that limits functional capabilities of an electronic device with a visual display.

Regarding to the first embodiment of the invention described herein, which relates to the method of designation of parts of a visual display, any prior arts close or similar to the nature of the invention described herein have not been found.

Regarding to the second embodiment of the invention described herein, which relates to a device for realizing the method of designation of parts of a visual display, any prior arts close or similar to the nature of the invention described herein have not been found.

Regarding to the third, fourth, fifth, sixth, seventh and eight embodiments of the invention described herein, which relate to the method of arrangement of visual display in an electronic device, it is known WO 2011/043691 A1, wherein a visual display is arranged on at least three sides of an electronic device body (see WO 2011/043691, Abstract). The technical solution described in WO 2011/043691 is the prototype of the third, fourth, fifth, sixth, seventh and eight embodiments of the invention described herein.

The disadvantage of the mentioned technical solution described in WO 2011/043691 is that it describes only the special case of arrangement of a visual display in an electronic device and it hasn't that variability of arrangement of a visual display in an electronic device as described herein in the third, fourth, fifth, sixth, seventh and eighth embodiments of the invention.

### OBJECTIVES AND DESCRIPTION OF THE INVENTION

The object and the technical result of the declared method and device for the method realization is to improve functional options of a visual display by applying the method of designation and arrangement of a visual display.

For proper understanding and interpretation of the text and claims described herein the following terms are used:

Display is a visual display, representing itself a flexible or non-flexible or partially flexible touch screen display or a flexible or non-flexible or partially flexible display of non-sensor type or a flexible or non-flexible or partially flexible partially touch screen display.

Partially touch screen display is a visual display with at least one touch screen part and at least one part of a non-sensor type, or a visual display, where at least one of its parts can change its functional operation from a touch screen into a non-sensor type or vice versa.

Partially flexible display is a visual display, comprising at least one flexible part and at least one non flexible part.

Difference in roughness between display parts is a difference between resistance of the surface of visual display parts to a finger touching and moving on it in all directions or at least in one direction, all other conditions being equal. And as used herein the term a <<rougher surface>> implies that the said surface has higher resistance to a finger moving on it in all directions or at least in one direction, all other conditions being equal, relative to the surface or surfaces it is compared to. And as used herein the term a <<less rough surface>> implies that the said surface has lower resistance to a finger moving on it in all directions or at least in one direction, all other conditions being equal, relative to the surface or surfaces it is compared to.

Referring to the first embodiment of the invention the above mentioned technical result is achieved as follows:

a surface or a part of the surface at least of one part of a visual display reflects the incident light otherwise than a surface or a part of the surface at least of one another part of a visual display, or

tactile perception is different when the finger touches a surface or part of the surface at least of one part of a visual display and when the finger touches a surface or part of the surface at least of one another part of a visual display, or

a surface or part of the surface at least of one part of a visual display has a convex shape or a concave shape, herewith said shape is constant or is configured to be transformed into another shapes, or

at least one part of the surface of each of designated parts of a visual display has a convex shape and at least one part of the surface of each of designated parts of a visual display has a concave shape, herewith said shape is constant or is configured to be transformed into another shapes, or

one part or several parts of a flexible or a partially flexible visual display has/have higher or lower torsional stiffness than another part or parts of the said visual display, or

transparency level at least of one part of a visual display differs from transparency level at least of one another part of a visual display;

herewith, a visual display is a flexible or non-flexible or partially flexible touch screen display or a flexible or non-flexible or partially flexible a visual display of a non-sensor type or a flexible or non-flexible or partially flexible a partially touch screen display.

Referring to the second embodiment of the invention the above mentioned technical result is achieved as follows:

a surface or a part of the surface at least of one part of a visual display reflects the incident light otherwise than a surface or a part of the surface at least of one another part of a visual display, and/or

at least one part of a visual display has a rough surface or ribbed surface, and/or

at least of one part of a visual display is transparent or semi-transparent, and/or

at least one part of a visual display has a flexible part or parts and a non-flexible part or parts, and/or

one part or parts of a visual display has a convex shape and/or a concave shape, herewith said shape/shapes is/are constant or is/are configured to be transformed into another shape/shapes, and/or

at least one part of a flexible or a partially flexible visual display has/have higher or lower torsional stiffness than at least one another part of the said visual display;

herewith, a visual display is a flexible or non-flexible or partially flexible touch screen display or a flexible or non-flexible or partially flexible a visual display of a non-sensor type or a flexible or non-flexible or partially flexible a partially touch screen display.

If there are at least two parts of a visual display with a rough surface, the surface at least of one part of a visual display may be rougher or less rough as compared to the surface at least of one another part of a visual display.

A convex shape of a part of a visual display and/or a concave shape of a part of a visual display may be configured to allow changing their/its size and/or configuration and/or location on the visual display.

The size and/or configuration and/or location of a convex part of a visual display and/or the concave part of a visual display may be changed due to a visual display transformation.

The surface or a part of the surface at least of one convex part of a visual display and/or the surface or a part of the surface at least of one concave part of a visual display may be rough or ribbed or may form a pattern or a symbol or an alphabet character or a numeric character.

At least one part of a visual display, which has a convex shape and/or a concave shape, may be a part of a touch screen display or may be a part of that part of a visual display which is a touch screen.

A higher torsional stiffness of one part or parts of a visual display as compared to another part or parts of a visual display may be obtained due to a larger thickness of the part or parts of a visual display as compared to another part or parts of a visual display and/or due to a material or materials used in the said parts of a visual display, which are different from materials used in another parts of a visual display.

Referring to the third embodiment of the invention the above mentioned technical result is achieved as follows:

A visual display of a non-sensor type (non-touch screen display) or a part of the visual display of a non-sensor type of an electronic device is arranged on two or three or four or more than four sides of the electronic device, herewith the said visual display is flexible or non-flexible or partially flexible; herewith the said visual display covers fully or partially each side of the electronic device, where it is arranged.

If a visual display of an electronic device is arranged on two sides of the electronic device body, these sides may be as follows:

two lateral sides of the electronic device body, or

the face side and the short lateral side of the electronic device body, or

the face side and the long lateral side of the electronic device body, or

the side of the electronic device body, which is opposite to the face side of the electronic device body, and the long lateral side, or

the back side and the short lateral side of the electronic device body, or

the back side and the long lateral side of the electronic device body, or

the inner and the outer side of the electronic device body, or

two inner sides of the electronic device body.

If a visual display of an electronic device is arranged on three sides of the electronic device body, these sides may be as follows:

the outer face side of the electronic device body, the outer side of the electronic device body, which is opposite to the face side of the electronic device body, and one outer lateral side of the electronic device body, herewith if the length of the electronic device body is different from its width, then this lateral side is understood as one of the long or short lateral side of the electronic device body, or

three outer lateral sides of the electronic device body, or

the outer face side of the electronic device body or the outer side of the electronic device body, which is opposite to the face side of the electronic device body, and two outer lateral sides of the electronic device body, herewith said lateral sides are adjacent or not adjacent to each other, or

one internal or outer lateral side of the electronic device body and two sides, adjacent to the said lateral side of the electronic device body.

If a visual display of an electronic device is arranged on four sides of the electronic device body, these sides may be as follows:

the face side of the electronic device body, the outer side, which is opposite to the face side of the electronic device body, and two outer lateral sides of the electronic device body, herewith if the length of the electronic device body is different from its width, then, either the said outer lateral sides of the electronic device body are understood as long or short lateral sides, or one of the said lateral sides is understood as a long lateral side of the electronic device body, and the other (second) side is understood as a short lateral side of the electronic device body, or

four outer lateral sides of the electronic device body, or

the face side of the electronic device body or the outer side, which is opposite to the face side of the electronic device body, and three outer lateral sides of the electronic device body.

A visual display or a part of the visual display may be non-removable or partially or fully removable.

The said electronic device may be a monitor or a mobile phone or a smart phone or a communicator or a notebook or a netbook or a tablet computer or an electronic book or a multimedia device or a game console or a game system device or a remote control device or a camcorder or a digital camera or a navigator or any other electronic device with a visual display of a non-sensor type.

Referring to the fourth embodiment of the invention the above mentioned technical result is achieved as follows:

A fully or partially touch screen display or a part of a fully or partially touch screen display of an electronic device is arranged on two sides of the electronic device body; herewith the said visual display is flexible or non-flexible or partially flexible; herewith the said visual display covers fully or partially each side of the electronic device, where it is arranged.

The specified two sides of the electronic device body may be as follows:

two lateral sides of the electronic device body, or

the face side and the short lateral side of the electronic device body, or

the face side and the long lateral side of the electronic device body, or

the side of the electronic device body, which is opposite to the face side of the electronic device body and long lateral side of the electronic device body, or

the back side and the short lateral side of the electronic device body, or

the back side and the long lateral side of the electronic device body, or

the inner and the outer side of the electronic device body, or

two inner sides of the electronic device body.

A visual display or a part of a visual display may be non-removable or partially or fully removable.

The said electronic device may be a monitor or a mobile phone or a smart phone or a communicator or a notebook or a netbook or a tablet computer or an electronic book or a multimedia device or a game console or a game system device or a remote control device or a camcorder or a digital camera or a navigator or any other electronic device with a fully or partially touch screen display.

Referring to the fifth embodiment of the invention the above mentioned technical result is achieved as follows:

The sides of a fully or partially touch screen display or the sides of a part of a fully or partially touch screen display arranged on three sides of the electronic device body are as follows:

the face side of the electronic device body, the side of the electronic device body, which is opposite to the face side of the electronic device body, and one lateral side of the electronic device body, herewith if the length of the electronic device body is different from its width, then this lateral side is understood as one of the long or short lateral side of the electronic device body, or

three lateral sides of the electronic device body, or

the face side of the electronic device body or the outer side of the electronic device body, which is opposite to the face side of the electronic device body, and two outer lateral sides of the electronic device body, herewith said lateral sides are adjacent or not adjacent to each other, or

one inner or outer lateral side of the electronic device body and two sides, adjacent to the said lateral side of the electronic device body;

herewith the said visual display is flexible or non-flexible or partially flexible;

herewith the said visual display covers fully or partially each side of the electronic device, where it is arranged.

A visual display or a part of a visual display may be non-removable or partially or fully removable.

The said electronic device may be a monitor or a mobile phone or a smart phone or a communicator or a notebook or a netbook or a tablet computer or an electronic book or a multimedia device or a game console or a game system device or a remote control device or a camcorder or a digital camera or a navigator or any other electronic device with a fully or partially touch screen display.

Referring to the sixth embodiment of the invention the above mentioned technical result is achieved as follows:

The sides of a fully or partially touch screen display or the sides of a part of a fully or partially touch screen display arranged on four or more than four sides of the electronic device body are as follows:

the face side of the electronic device body, the outer side, which is opposite to the face side of the electronic device body, and two outer lateral sides of the electronic device body, herewith if the length of the electronic device body is different from its width, then, either the said outer lateral sides of the electronic device body are understood as long or short lateral sides, or one of the said lateral sides is understood as a long lateral side of the electronic device body, and the other (second) side is understood as a short lateral side of the electronic device body, or

four outer lateral sides of the electronic device body, or

the face side of the electronic device body or the outer side, which is opposite to the face side of the electronic device body and three outer lateral sides of the electronic device body;

herewith the said visual display is flexible or non-flexible or partially flexible;

herewith the said visual display covers fully or partially each side of the electronic device, where it is arranged.

A visual display or a part of a visual display may be non-removable or partially or fully removable.

The said electronic device may be a monitor or a mobile phone or a smart phone or a communicator or a notebook or a netbook or a tablet computer or an electronic book or a multimedia device or a game console or a game system device or a remote control device or a camcorder or a digital camera or a navigator or any other electronic device with a fully or partially touch screen display.

Referring to the seventh embodiment of the invention the above mentioned technical result is achieved as follows:

At least two parts of a visual display, fully or partially arranged on two or three or four or more than four sides of the electronic device, are configured to change their mutual position to each other via transformation of an electronic device, on which the said display is arranged; herewith the said visual display covers fully or partially each side of the electronic device, where it is arranged; herewith the said visual display is a fully or partially touch screen display or a visual display of non a sensor type; herewith the said visual display is a flexible or partially flexible or non-flexible.

When parts of a visual display change their mutual position, then, a location and/or a size of displaying at least of one virtual symbol and/or at least of one virtual object and/or the method of their displaying may be changed.

A visual display or a part of a visual display may be non-removable or partially or fully removable.

The said electronic device may be a monitor or a mobile phone or a smart phone or a communicator or a notebook or a netbook or a tablet computer or an electronic book or a multimedia device or a game console or a game system device or a remote control device or a camcorder or a digital camera or a navigator or any other electronic device with a visual display.

Referring to the eighth embodiment of the invention the above mentioned technical result is achieved as follows:

a part of a visual display is arranged on the outer part of the electronic device body and the another part of the visual display is arranged outside of the electronic device body, or

a part of the visual display is arranged on the outer part of the electronic device body and the another part of the visual display is arranged outside of the electronic device body and inside the body of the electronic device, or

a part of the visual display is arranged on the outer part of the electronic device body and the another part of the visual display is arranged inside the body of the electronic device.

A part of a visual display may be arranged on two or three or four or more than four sides of the electronic device body.

A part of a visual display arranged inside the electronic device body may be rolled up either wholly or partially and then may be unrolled either wholly or partially; when a part of a visual display is unrolling the said part of the display is coming out of the device fully or partially.

A location and/or a size at least of one displayed virtual object may be changed when visible display surface area is enlarged or reduced and/or when the operating part area of the display is changed.

A part or parts of the touch screen display may have higher torsional stiffness as compared to another parts of the display.

A visual display or a part of a visual display may be non-removable or partially or fully removable.

The said electronic device may be a monitor or a mobile phone or a smart phone or a communicator or a notebook or a netbook or a tablet computer or an electronic book or a multimedia device or a game console or a game system device or a remote control device or a camcorder or a digital camera or a navigator or any other electronic device with a visual display.

### PREFERRED EMBODIMENT OF THE INVENTION

The method of designation of a visual display concerning the first embodiment of the invention described herein is feasible as can be realized due to application of prior art technical solutions, software and technical means.

The device for realizing the method of designation of a visual display concerning the second embodiment of the invention described herein is feasible as can be realized due to application of prior art technical solutions, software and technical means.

The method of arrangement of a visual display concerning the third, fourth, fifth, sixth, seventh and eighth embodiments of the invention described herein is feasible as can be realized due to application of prior art technical solutions, software and technical means.

### APPLICATIONS OF THE INVENTION

The method of designation of a visual display and device for realization of the method may be widely applicable in designation displays parts.

The method of arrangement of a visual display may be widely applicable in electronics to improve functional options of a visual display.

1. A method of designation of parts of a visual display of an electronic device, wherein:
a surface or a part of the surface at least of one part of a visual display reflects the incident light otherwise than a surface or a part of the surface at least of one another part of a visual display,
or
tactile perception is different when the finger touches a surface or part of the surface at least of one part of a visual display and when the finger touches a surface or part of the surface at least of one another part of a visual display,
or
a surface or part of the surface at least of one part of a visual display has a convex shape or a concave shape, herewith said shape is constant or is configured to be transformed into another shapes,
or
at least one part of the surface of each of designated parts of a visual display has a convex shape and at least one part of the surface of each of designated parts of a visual display has a concave shape, herewith said shape is constant or is configured to be transformed into another shapes,
or
one part or several parts of a flexible or a partially flexible visual display has/have higher or lower torsional stiffness than another part or parts of the said visual display,
or
transparency level at least of one part of a visual display differs from transparency level at least of one another part of a visual display.
herewith, a visual display is a flexible or non-flexible or partially flexible touch screen display or a flexible or non-flexible or partially flexible a visual display of a non-sensor type or a flexible or non-flexible or partially flexible a partially touch screen display

2. A visual display of an electronic device, wherein:
a surface or a part of the surface at least of one part of a visual display reflects the incident light otherwise than a surface or a part of the surface at least of one another part of a visual display,
and/or
at least one part of a visual display has a rough surface or ribbed surface,
and/or
at least of one part of a visual display is transparent or semi-transparent,
and/or
at least one part of a visual display has a flexible part or parts and a non-flexible part or parts,
and/or
one part or parts of a visual display has a convex shape and/or a concave shape, herewith said shape/shapes is/are constant or is/are configured to be transformed into another shape/shapes,
and/or
at least one part of a flexible or a partially flexible visual display has/have higher or lower torsional stiffness than at least one another part of the said visual display. herewith, a visual display is a flexible or non-flexible or partially flexible touch screen display or a flexible or non-flexible or partially flexible a visual display of a non-sensor type or a flexible or non-flexible or partially flexible a partially touch screen display.

3. The device according to claim 2, wherein if there are at least two parts of a visual display with a rough surface, the surface at least of one part of a visual display is rougher or less rough as compared to the surface at least of one another part of a visual display.

4. The device according to claim 2, wherein a convex shape of a part of a visual display and/or a concave shape of a part of a visual display are/is configured to allow changing their/its size and/or configuration and/or location on the visual display.

5. The device according to claim 4, wherein the size and/or configuration and/or location of a convex part of a visual display and/or the concave part of a visual display are/is changed due to a visual display transformation.

6. The device according to claim 2, wherein the surface or apart of the surface at least of one convex part of a visual display and/or the surface or a part of the surface at least of one concave part of a visual display are/is rough or ribbed or form/forms a pattern or a symbol or an alphabet character or a numeric character.

7-25. (canceled)

26. The device according to claim 2, wherein at least one part of a visual display, which has a convex shape and/or a concave shape, is the part of a touch screen display or is the part of that part of a visual display which is a touch screen.

27. The device according to claim 2, wherein a higher torsional stiffness of one part or parts of a visual display as compared to another part or parts of a visual display is obtained due to a larger thickness of the part or parts of a visual display as compared to another part or parts of a visual display and/or due to a material or materials used in the said parts of a visual display, which are different from materials used in another parts of a visual display.

28. A method of arrangement of a visual display in an electronic device, wherein a visual display of a non-sensor type (non-touch screen display) or a part of the visual display of a non-sensor type of an electronic device is arranged on two or three or four or more than four sides of the electronic device,
herewith the said visual display is flexible or non-flexible or partially flexible;
herewith the said visual display covers fully or partially each side of the electronic device, where it is arranged.

29. The method according to claim 28, wherein:
if a visual display of an electronic device is arranged on two sides of the electronic device body, these sides are as follows:
two lateral sides of the electronic device body,
or
the face side and the short lateral side of the electronic device body,
or
the face side and the long lateral side of the electronic device body,
or
the side of the electronic device body, which is opposite to the face side of the electronic device body, and the long lateral side,
or
the back side and the short lateral side of the electronic device body,
or
the back side and the long lateral side of the electronic device body,
or
the inner and the outer side of the electronic device body,
or
two inner sides of the electronic device body.

30. The method according to claim 28, wherein:
if a visual display of an electronic device is arranged on three sides of the electronic device body, these sides are as follows:
the outer face side of the electronic device body, the outer side of the electronic device body, which is opposite to the face side of the electronic device body, and one outer lateral side of the electronic device body, herewith if the length of the electronic device body is different from its width, then this lateral side is understood as one of the long or short lateral side of the electronic device body,
or
three outer lateral sides of the electronic device body,
or
the outer face side of the electronic device body or the outer side of the electronic device body, which is opposite to the face side of the electronic device body, and two outer lateral sides of the electronic device body, herewith said lateral sides are adjacent or not adjacent to each other,
or
one internal or outer lateral side of the electronic device body and two sides, adjacent to the said lateral side of the electronic device body.

31. The method according to claim 28, wherein:
if a visual display of an electronic device is arranged on four sides of the electronic device body, these sides are as follows:
the face side of the electronic device body, the outer side, which is opposite to the face side of the electronic device body, and two outer lateral sides of the electronic device body, herewith if the length of the electronic device body is different from its width, then, either the said outer lateral sides of the electronic device body are understood as long or short lateral sides, or one of the said lateral sides is understood as a long lateral side of the electronic device body, and the other (second) side is understood as a short lateral side of the electronic device body,
or
four outer lateral sides of the electronic device body,
or
the face side of the electronic device body or the outer side, which is opposite to the face side of the electronic device body, and three outer lateral sides of the electronic device body.

32. The method according to claim 28, wherein a visual display or a part of the visual display is non-removable or partially or fully removable.

33. The method according to claim 28, wherein the said electronic device is a monitor or a mobile phone or a smart phone or a communicator or a notebook or a netbook or a tablet computer or an electronic book or a multimedia device or a game console or a game system device or a remote control device or a camcorder or a digital camera or a navigator or any other electronic device with a visual display of a non-sensor type.

34. A method of arrangement of a s visual display in an electronic device, wherein:
a fully or partially touch screen display or a part of a fully or partially touch screen display of an electronic device is arranged on two sides of the electronic device body;
herewith the said visual display is flexible or non-flexible or partially flexible;
herewith the said visual display covers fully or partially each side of the electronic device, where it is arranged;

35. The method according to claim 34, wherein the specified two sides of the electronic device body are the following sides:
two lateral sides of the electronic device body,
or
the face side and the short lateral side of the electronic device body,
or
the face side and the long lateral side of the electronic device body,
or
the side of the electronic device body, which is opposite to the face side of the electronic device body and long lateral side of the electronic device body,
or
the back side and the short lateral side of the electronic device body,
or
the back side and the long lateral side of the electronic device body,
or
the inner and the outer side of the electronic device body,
or
two inner sides of the electronic device body.

36. The method according to claim 34, wherein a visual display or a part of a visual display is non-removable or partially or fully removable.

37. The method according to claim 34, wherein the said electronic device is a monitor or a mobile phone or a smart phone or a communicator or a notebook or a netbook or a tablet computer or an electronic book or a multimedia device or a game console or a game system device or a remote control device or a camcorder or a digital camera or a navigator or any other electronic device with a fully or partially touch screen display.

38. A method of arrangement of a visual display in an electronic device comprising a fully or partially touch screen display or a part of a fully or partially touch screen display arranged on three sides of an electronic device body,
wherein the sides of a fully or partially touch screen display or the sides of a part of a fully or partially touch screen display arranged on three sides of the electronic device body are as follows:
the face side of the electronic device body, the side of the electronic device body, which is opposite to the face side of the electronic device body, and one lateral side of the electronic device body, herewith if the length of the electronic device body is different from its width, then this lateral side is understood as one of the long or short lateral side of the electronic device body,
or
three lateral sides of the electronic device body,
or
the face side of the electronic device body or the outer side of the electronic device body, which is opposite to the face side of the electronic device body, and two outer lateral sides of the electronic device body, herewith said lateral sides are adjacent or not adjacent to each other,
or
one inner or outer lateral side of the electronic device body and two sides, adjacent to the said lateral side of the electronic device body;
herewith the said visual display is flexible or non-flexible or partially flexible;
herewith the said visual display covers fully or partially each side of the electronic device, where it is arranged.

39. The method according to claim 38, wherein a visual display or a part of a visual display is non-removable or partially or fully removable.

40. The method according to claim 38, wherein the said electronic device is a monitor or a mobile phone or a smart phone or a communicator or a notebook or a netbook or a tablet computer or an electronic book or a multimedia device or a game console or a game system device or a remote control device or a camcorder or a digital camera or a navigator or any other electronic device with a fully or partially touch screen display.

41. A method of arrangement of a visual display in an electronic device comprising a fully or partially touch screen display or a part of fully or partially touch screen display arranged on four or more than four sides of the electronic device body, wherein the sides of a fully or partially touch screen display or the sides of a part of a fully or partially touch screen display arranged on four or more than four sides of the electronic device body are as follows:
the face side of the electronic device body, the outer side, which is opposite to the face side of the electronic device body, and two outer lateral sides of the electronic device body, herewith if the length of the electronic device body is different from its width, then, either the said outer lateral sides of the electronic device body are understood as long or short lateral sides, or one of the said lateral sides is understood as a long lateral side of the electronic device body, and the other (second) side is understood as a short lateral side of the electronic device body,
or
four outer lateral sides of the electronic device body,
or
the face side of the electronic device body or the outer side, which is opposite to the face side of the electronic device body and three outer lateral sides of the electronic device body;
herewith the said visual display is flexible or non-flexible or partially flexible;
herewith the said visual display covers fully or partially each side of the electronic device, where it is arranged.

42. The method according to claim 41, wherein a visual display or a part of a visual display is non-removable or partially or fully removable.

43. The method according to claim 41, wherein the said electronic device is a monitor or a mobile phone or a smart phone or a communicator or a notebook or a netbook or a tablet computer or an electronic book or a multimedia device or a game console or a game system device or a remote control device or a camcorder or a digital camera or a navigator or any other electronic device with a fully or partially touch screen display.

44. A method of arrangement of a visual display in an electronic device, wherein at least two parts of a visual display, fully or partially arranged on two or three or four or more than four sides of the electronic device, are configured to change their mutual position to each other via transformation of an electronic device, on which the said display is arranged;
herewith the said visual display covers fully or partially each side of the electronic device, where it is arranged;
herewith the said visual display is a fully or partially touch screen display or a visual display of non a sensor type;
herewith the said visual display is a flexible or partially flexible or non-flexible.

45. The method according to claim 44, wherein when parts of a visual display change their mutual position, then, a location and/or a size of displaying at least of one virtual symbol and/or at least of one virtual object and/or the method of their displaying is/are changed.

46. The method according to claim 44, wherein a visual display or a part of a visual display is non-removable or partially or fully removable.

47. The method according to claim 44, wherein the said electronic device is a monitor or a mobile phone or a smart phone or a communicator or a notebook or a netbook or a tablet computer or an electronic book or a multimedia device or a game console or a game system device or a remote control device or a camcorder or a digital camera or a navigator or any other electronic device with a visual display.

48. A method of arrangement of a visual display in an electronic device, wherein:
a part of a visual display is arranged on the outer part of the electronic device body and the another part of the visual display is arranged outside of the electronic device body,
or
a part of the visual display is arranged on the outer part of the electronic device body and the another part of the visual display is arranged outside of the electronic device body and inside the body of the electronic device,
or
a part of the visual display is arranged on the outer part of the electronic device body and the another part of the visual display is arranged inside the body of the electronic device.

49. The method according to claim 48, wherein a part of a visual display is arranged on two or three or four or more than four sides of the electronic device body.

50. The method according to claim 48, wherein a part of a visual display arranged inside the electronic device body is rolled up either wholly or partially and then unrolled either wholly or partially; when a part of a visual display is unrolling the said part of the display is coming out of the device fully or partially.

51. The method according to claim 48, wherein a location and/or a size at least of one displayed virtual object are/is changed when visible display surface area is enlarged or reduced and/or when the operating part area of the display is changed.

52. The method according to claim 48, wherein a part or parts of the touch screen display has/have higher torsional stiffness as compared to another parts of the display.

53. The method according to claim 48, wherein a visual display or a part of a visual display is non-removable or partially or fully removable.

54. The method according to claim 48, wherein the said electronic device is a monitor or a mobile phone or a smart phone or a communicator or a notebook or a netbook or a tablet computer or an electronic book or a multimedia device or a game console or a game system device or a remote control device or a camcorder or a digital camera or a navigator or any other electronic device with a visual display.
